(19) United States
(12) Patent Application Publication
(10) Pub. No.: US 2015/0204255 A1
(43) Pub. Date: Jul. 23, 2015

(54) VEHICLE CONTROL APPARATUS AND VEHICLE CONTROL METHOD

(71) Applicant: Hiroaki SEGUCHI, Aichi-ken (JP)

(72) Inventor: Hiroaki Seguchi, Toyota-shi (JP)

(73) Assignee: TOYOTA JIDOSHA KABUSHIKI KAISHA, Toyota-shi, Aichi-ken (JP)

(21) Appl. No.: 14/426,000

(22) PCT Filed: Dec. 9, 2013
(86) PCT No.: PCT/IB2013/002977

§ 371 Date: Mar. 4, 2015

(30) Foreign Application Priority Data
Dec. 10, 2012 (JP) 2012-269583

(51) Int. Cl. F02D 29/02; F02N 11/08; F02D 41/04

(52) U.S. Cl. CPC F02D 29/02; F02D 41/042; F02D 41/045; F02N 11/0822

(57) ABSTRACT

In a vehicle control apparatus mounted in a vehicle capable of executing an idle stop control, engine restart conditions for the idle stop control include at least a first condition that an accelerator pedal is depressed and a brake pedal is released. If both the brake pedal and the accelerator pedal are depressed during an automatic stop of the engine, the first condition is changed to a condition that the accelerator pedal is depressed to or beyond a pre-set value A so that it is less easy to restart the engine than if the brake pedal is released.

### BACKGROUND OF THE INVENTION

1. Field of the Invention

The invention relates to a vehicle control apparatus and a vehicle control method.

2. Description of Related Art

There has been known a vehicle control apparatus that executes a generally termed idle stop control of automatically stopping the engine if a predetermined condition that the vehicle speed is zero, the brake is on, etc. is satisfied, and automatically restarting the engine if a predetermined engine restart condition is satisfied during an automatically stopped engine state (see, e.g., Japanese Patent Application Publication No. 11-030139 (JP 11-030139A)).

In this vehicle control apparatus, the turning-on of the accelerator or the turning-off of the brake during an automatic stop of the engine is regarded as a driver's intention to launch the vehicle, and then the engine is restarted.

However, according to the foregoing vehicle control apparatus, even in the case where, for example, the accelerator is turned on while the brake is on, the vehicle control apparatus considers that the driver has an intention to launch the vehicle because the accelerator is on, and then restarts the engine.

Therefore, the foregoing vehicle control apparatus restarts the engine even when it is not clear whether to give priority to the driver's intention to stop the vehicle detected on the basis of the turning-on of the brake or the driver's intention to launch the vehicle detected on the basis of the turning-on of the accelerator, and therefore may possibly fail to perform the restarting of the engine commensurate with the driver's actual intention.

For example, in the case where while the driver is intentionally depressing the brake pedal, the driver's foot is also on the accelerator pedal by mistake (i.e., in the case of the both-pedal depression due to the driver's operation error), the engine is restarted despite absence of the driver's intention to launch the vehicle, that is, the operation of the vehicle control apparatus disagrees with the driver's intention.

### SUMMARY OF THE INVENTION

The invention provides a vehicle control apparatus and a vehicle control method capable of performing restart of an internal combustion engine commensurate with the intention of a driver at the time of restarting the engine from an idle stop control.

A vehicle control apparatus in accordance with a first aspect of the invention is a vehicle control apparatus mounted in a vehicle executing an idle stop control of automatically stopping the internal combustion engine when a predetermined engine stop condition is satisfied, and restarting the internal combustion engine when a predetermined engine restart condition is satisfied. The vehicle control apparatus has a construction that includes: a first sensor configured to detect amount of depression of an accelerator pedal; and a second sensor configured to detect amount of depression of a brake pedal. In this construction, the predetermined engine restart condition includes at least a first condition that the accelerator pedal is depressed and the brake pedal is released. Furthermore, if it is detected by the first sensor and the second sensor that both the brake pedal and the accelerator pedal are depressed during an automatic stop of the internal combustion engine, the first condition is changed to a condition that the accelerator pedal is depressed to or beyond a pre-set value so that it is less easy to restart the internal combustion engine than if depression of the brake pedal is released.

Due to this construction, if both the brake pedal and the accelerator pedal are depressed during the automatic stop of the internal combustion engine, the vehicle control apparatus in accordance with the first aspect of the invention changes the first condition concerning the accelerator pedal to a condition that the accelerator pedal is depressed to or beyond the pre-set value so that it will be less easy to restart the internal combustion engine. Therefore, restart of the internal combustion engine is restricted, for example, if a driver puts his/her foot on the accelerator pedal without an intention to launch the vehicle while keeping the brake pedal depressed. On the other hand, if both the accelerator pedal and the brake pedal are simultaneously depressed and the accelerator pedal is depressed to or beyond the predetermined value due to the driver's intention to launch the vehicle, the internal combustion engine is restarted. Therefore, the vehicle control apparatus in accordance with the first aspect of the invention is able to perform restart of the internal combustion engine commensurate with a driver's intention at the time of return from the idle stop control.

Furthermore, in the case where restart of the internal combustion engine and launch of the vehicle are to be carried out by depressing the accelerator pedal while keeping the brake pedal depressed on an uphill road or the like, since the internal combustion engine is restarted after the accelerator pedal is depressed to or beyond the predetermined value, a sufficient drive force can be produced at the time of launching the vehicle in comparison with the case where the internal combustion engine is restarted while the amount of depression of the accelerator pedal is small. This makes it possible to restrain the vehicle from descending backward at the time of launch on an uphill road or the like. Therefore, the vehicle control apparatus in accordance with the first aspect of the invention is able to improve the vehicle's launch performance on an uphill road or the like.

The vehicle control apparatus in accordance with the first aspect of the invention based on the foregoing construction may further have a construction in which when it is detected by the first sensor and the second sensor that both the brake pedal and the accelerator pedal are depressed during the automatic stop of the internal combustion engine and the amount of depression of the accelerator pedal is less than the predetermined value, restart of the internal combustion engine is prohibited.

Due to this construction, the vehicle control apparatus in accordance with the first aspect of the invention prohibits restart of the internal combustion engine provided that the amount of depression of the accelerator pedal is less than the predetermined value in the case where both the brake pedal and the accelerator pedal are depressed during the automatic stop of the internal combustion engine. Therefore, in the case where the accelerator pedal is depressed by a driver's operation error when the driver does not intend to launch the vehicle, restart of the internal combustion engine can be restricted according to the driver's intention.

The vehicle control apparatus in accordance with the first aspect of the invention based on one of the foregoing constructions may further have a construction in which if it is determined by the first sensor and the second sensor that both the brake pedal and the accelerator pedal are depressed during the automatic stop of the internal combustion engine and the first condition is changed, the changing of the first condition may be notified to the driver via a controller.

Due to this construction, in the vehicle control apparatus in accordance with the first aspect of the invention, if during the automatic stop of the internal combustion engine, both the brake pedal and the accelerator pedal are depressed and the first condition is changed so that it is less easy to restart the internal combustion engine, this changing of the first condition is notified to the driver. Therefore, it is possible to restrain unintentional launch of the vehicle or the like due to a driver's depressing the accelerator pedal based on, for example, the driver's misunderstanding of the automatic stop of the internal combustion engine as an ignition-off state.

In accordance with a second aspect of the invention, a vehicle control method for a vehicle that executes an idle stop control of automatically stopping an internal combustion engine when a predetermined engine stop condition is satisfied, and restarting the internal combustion engine when a predetermined engine restart condition is satisfied includes: detecting amount of depression of an accelerator pedal; detecting amount of depression of a brake pedal; determining that the predetermined engine restart condition is satisfied as a first condition when the accelerator pedal is depressed and the brake pedal is released; and determining that the predetermined engine restart condition is satisfied as a second condition when the accelerator pedal is depressed beyond the amount of depression of the accelerator pedal at which the first condition is satisfied while both the brake pedal and the accelerator pedal are depressed during an automatic stop of the internal combustion engine.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a general construction diagram of a vehicle equipped with a vehicle control apparatus in accordance with an embodiment of the invention; and

FIG. 2 is a flowchart showing an engine restart condition changing process that is executed by the vehicle control apparatus in accordance with the embodiment of the invention.

### DETAILED DESCRIPTION OF EMBODIMENTS

Embodiments of the invention will be described hereinafter with reference to the drawings.

In the following description, examples in which a vehicle control apparatus in accordance with the invention is applied, to a front-engine rear-drive (FR) vehicle that is equipped with a transmission. Incidentally, a vehicle control apparatus in accordance with the invention is applicable to not only the FR vehicles but also FF vehicles, four-wheel drive vehicles, etc.

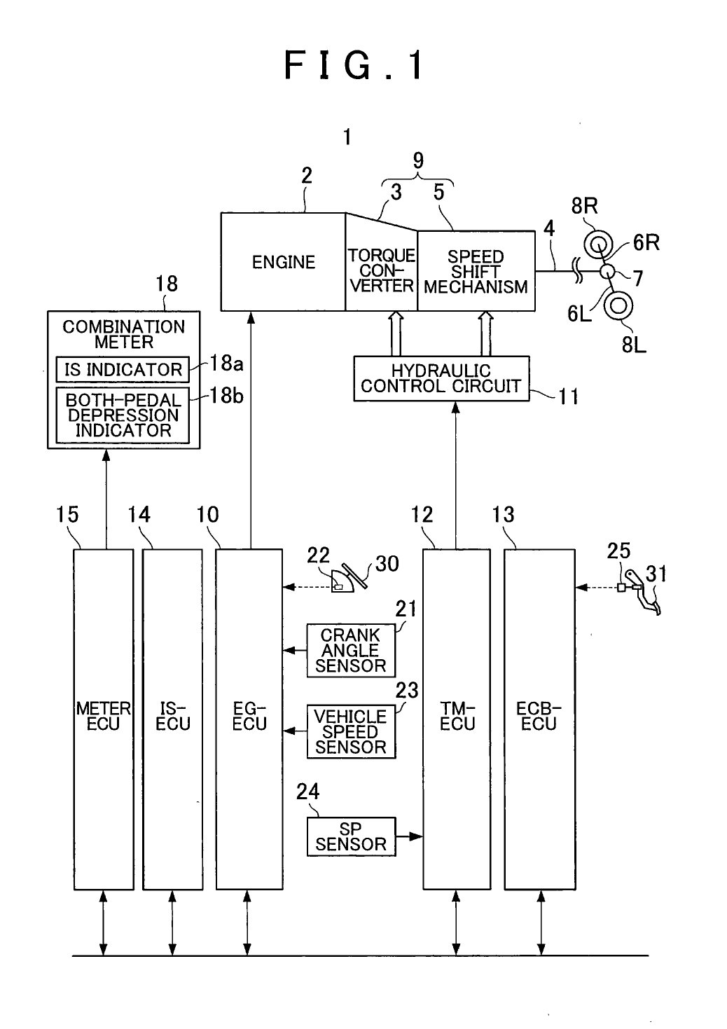

As shown in FIG. 1, a vehicle 1 in this embodiment includes: an engine 2 that constitutes an internal combustion engine; a torque converter 3 that amplifies output torque from the engine 2; a speed shift mechanism 5 that rotates an output shaft 4 at rotation speed that is changed from the rotation speed of an output shaft of the torque converter 3; a differential 7 that transfers the turning power of the output shaft 4 of the speed shift mechanism 5 to drive shafts 6L and 6R; and driving wheels 8L and 8R that are driven as the drive shafts 6L and 6R are rotated.

The engine 2 is constituted by a spark ignition type multicylinder internal combustion engine, for example, a four-stroke in-line four-cylinder engine. Although in this embodiment, the engine 2 is constituted by the in-line four-cylinder engine, it is permissible in the invention that the engine be constituted by any one of various types of engines, such as an in-line six-cylinder engine, a V-type six-cylinder engine, a V-type twelve-cylinder engine, a horizontally opposed six-cylinder engine, etc.

The fuel used for the engine 2 is gasoline. However, instead of gasoline, the fuel may also be a hydrocarbon type fuel, such as light oil, etc., or an alcohol fuel combining gasoline and alcohol, such as ethanol or the like.

The torque converter 3 and the speed shift mechanism 5 constitute a transmission 9. As the transmission 9, it is possible to adopt a multi-speed automatic transmission that has a plurality of speed change steps that differ from each other in speed change ratio, a continuously variable transmission capable of continuously varying the speed change ratio, etc. The torque converter 3 transfers power between the engine 2 and the speed shift mechanism 5 via a fluid.

Furthermore, the vehicle 1 includes: an engine electronic control. unit (hereinafter, referred to as “EG-ECU”) 10 that controls the engine 2; a hydraulic control circuit 11 that controls the transmission 9 by hydraulic pressure; a transmission electronic control unit (hereinafter, referred to as “TM-ECU”) 12 that electrically controls the hydraulic control circuit 11; a brake electronic control unit (hereinafter, referred to as “ECB-ECU”) 13 that controls a brake apparatus (not shown) that generates braking force for the vehicle 1; an idling-stop electronic control unit (hereinafter, referred to as “IS-ECU”) that executes an idle stop control described later; and a meter ECU 15 that controls a combination meter 18.

The EG-ECU 10 is constructed of a microprocessor that includes a central processing unit (CPU), a read-only memory (ROM), a random access memory (RAM), a flash memory and an input/output port (none of which is shown in the drawings).

Programs for causing the microprocessor to function as the EG-ECU 10 are stored in the EG-ECU 10. That is, the microprocessor functions as the EG-ECU 10 because the CPU of the EG-ECU 10 executes the programs stored in the ROM by using the RAM as a working area.

In this embodiment, various sensors and the like, including a crank angle sensor 21, an accelerator operation amount sensor 22 that detects an accelerator operation amount that represents the amount of operation of an accelerator pedal 30, and a vehicle speed sensor 23 that detects the vehicle speed, are connected to the input side of the EG-ECU 10.

The accelerator operation amount sensor 22 is designed so that when the accelerator pedal 30 is operated by a driver, the sensor 22 outputs to the EG-ECU 10 a signal that represents the accelerator operation amount that indicates the amount of depression of the accelerator pedal 30, that is, the amount of operation of the accelerator pedal 30. Thus, the accelerator operation amount sensor 22 constitutes accelerator operation detection means in accordance with the invention.

The vehicle speed sensor 23 is designed so as to detect the rotation angles of the drive shafts 6L and 6R and output to the EG-ECU 10 a signal that represents a vehicle speed obtained by averaging the detected rotation angles of the drive shafts 6L and 6R.

The EG-ECU 10 is designed so as to communicate with other ECUs, such as the ECB-ECU 13, the IS-ECU 14, etc., via a high-speed CAN, and send and receive various control signals and data to and from the other ECUs such as the ECB-ECU 13, the IS-ECU 14, etc.

For example, the EG-ECU 10, on the basis of detection signals and the like input from various sensors that detect states of operation of the engine 2, performs operation controls of the engine 2, such as a fuel injection control, an injection control, an intake air flow adjusting control, etc., and outputs to the TM-ECU 12 data regarding the state of operation of the engine 2 according to need.

The TM-ECU 12 is constructed of a microprocessor that includes a CPU, a ROM, a RAM, a flash memory and an input/output port (none of which is shown in the drawings). Programs for causing the microprocessor to function as the TM-ECU 12 are stored in the ROM of the TM-ECU 12.

That is, the microprocessor functions as the TM-ECU 12 because the CPU of the TM-ECU 12 executes the programs stored in the ROM by using the RAM as a working area. Various sensors and the like, including a shift position sensor (SP sensor) 24 that detects the operation position of a shift lever, that is, the shift position”, are connected to the input side of the TM-ECU 12. Examples of the shift position include the “D range” for the forward run of the vehicle, the “N range” for the neutral position, the “R range” for the reverse run of the vehicle, etc.

, The TM-ECU 12 is designed so as to communicate with other ECUs, such as the EG-ECU 10, the IS-ECU 14, etc., via the high-speed CAN, and send and receive various control signals and data to and from the other ECUs such as the EG-ECU 10, the IS-ECU 14, etc.

For example, on the basis of the shift position detected by the shift position sensor (SP sensor) 24 and the state of operation of the engine 2, the TM-ECU 12 controls the hydraulic control circuit 11 so as to cause the speed shift mechanism 5 to establish one of the speed change steps, and outputs to the EG-ECU 10 information that represents the speed change step established by the speed shift mechanism 5.

The ECB-ECU 13 is constructed of a microprocessor that includes a CPU, a ROM, a RAM, a flash, memory and an input/output port (none of which is shown in the drawings). Programs for causing the microprocessor to function as the ECB-ECU 13 are stored in the ROM of the ECB-ECU 13.

That is, the microprocessor functions as the ECB-ECU 13 because the CPU of the ECB-ECU 13 executes the programs stored in the ROM by using the RAM as a working area. The brake sensor 25 that detects the amount of depression of the brake pedal 31, a brake actuator (not shown), etc. are connected to the input side of the ECB-ECU 13.

The brake sensor 25 is designed so that when the brake pedal 31 is operated by a driver, the sensor 25 outputs a signal that represents the amount of depression of the brake pedal 31 to other ECUs, for example, the IS-ECU 14 or the like. Thus, the brake sensor 25 constitutes brake operation detection means in accordance with the invention.

The ECB-ECU 13 is designed so as to communicate with other ECUs, such as the EG-ECU 10, the IS-ECU 14, etc., via the high-speed CAN, and send and receive various control signals and data to and from the other ECUs such as the EG-ECU 10, the IS-ECU 14, etc.

The IS-ECU 14 is constructed of a microprocessor that includes a CPU, a ROM, a RAM, a flash memory and an input/output port (none of which is shown in the drawings). Programs for causing the microprocessor to function as the IS-ECU 14 are stored in the ROM of the IS-ECU 14.

That is, the microprocessor functions as the IS-ECU 14 because the CPU of the IS-ECU 14 executes the programs stored in the ROM by using the RAM as a working area.

The IS-ECU 14 is designed so as to communicate with other ECUs, such as the EG-ECU 10, the ECB-ECU 13, etc., via the high-speed CAN, and send and receive various control signals and data to and from the other ECUs such as the EG-ECU 10, the ECB-ECU 13, etc.

The IS-ECU 14 is designed to execute the idle stop control of automatically stopping the engine 2 if a predetermined engine stop condition is satisfied, and automatically restarting the engine 2 if a predetermined engine restart condition is satisfied. This idle stop control is executed when the vehicle stops at an intersection or the like, in order to improve fuel economy, reduce emission of exhaust gas, reduce noise, etc.

For example, if all of predetermined engine stop conditions mentioned below are satisfied, the IS-ECU 14 temporarily stops the engine 2 by executing a control of closing the throttle valve, a control of stopping the supply of fuel from the injectors, etc.

On the other hand, if any one of predetermined engine restart conditions mentioned below is satisfied, the IS-ECU 14 restarts the engine 2 by, for example, restarting the supply of fuel from the injectors, or the like. Incidentally, these controls on the engine 2 are performed via the EG-ECU 10.

The aforementioned predetermined engine stop conditions include, for example, conditions regarding whether the shift position is the D range, whether the accelerator operation amount is a zero criterion value (that means a substantially zero value that includes zero) for determination that the accelerator operation amount is zero, whether the brake pedal 31 is depressed, whether the vehicle speed V is a zero criterion value (that means a substantially zero value that includes zero) for determination that the vehicle speed V is zero, etc.

Furthermore, the aforementioned engine restart conditions include, for example, conditions regarding whether during a stop of the vehicle with the shift position being the D range, the accelerator operation amount Acc becomes equal to a value that is not considered as being the zero criterion value, that is, the accelerator pedal 30 is depressed (the accelerator is turned on) (hereinafter, this condition will be referred to as the first condition), whether depression of the brake pedal 31 is released (discontinued), that is, whether the brake is turned off (hereinafter, referred to as the second condition), etc. Therefore, the IS-ECU 14 automatically restarts the engine 2 on the condition that during an automatic stop of the engine 2, the accelerator pedal 30 is depressed or the brake pedal, 31 is released from the depressed state.

Furthermore, the IS-ECU 14 is designed so that during the automatic stop of the engine 2, if it is detected by the brake sensor 25 and the accelerator operation amount sensor 22 that the brake pedal 31 and the accelerator pedal 30 are both depressed (a so-called both-pedal depression state), it is less easy to restart the engine 2 than if depression of the brake pedal 31 is released, that is, when the both-pedal depression state is not present.

Concretely, if the both-pedal depression state occurs during an automatically stopped state of the engine 2, the IS-ECU 14 changes the aforementioned first condition to a condition that the accelerator pedal 30 is depressed to an amount that is equal to or greater than a predetermined value (predetermined accelerator operation amount) A set beforehand. That is, in this embodiment, if the both-pedal depression state occurs during the automatic stop of the engine 2, the accelerator operation amount serving as a reference for permitting the restart of the engine 2 is changed. For example, during a state other than the both-pedal depression state, the engine 2 is restarted if the accelerator operation amount is greater than zero. On the other hand, during the both-pedal depression state, the engine 2 is not immediately restarted if the accelerator operation amount is greater than zero, but the engine 2 is restarted on the condition that the accelerator operation amount is greater than or equal to the predetermined value A.

It is to be noted herein that the aforementioned predetermined value A is, for example, an accelerator operation amount that is greater than at least an accelerator operation amount that is detected when, while keeping the brake pedal 31 depressed, a driver puts his/her foot on the accelerator pedal 30 as well (which is a so-called operation error), and an accelerator operation amount such that it can be determined that the driver has an intention to launch the vehicle.

Furthermore, it is preferable that the predetermined value A be variable according to the amount of depression of the brake pedal 31. More specifically, it is preferable to adopt a construction in which the greater the amount of depression of the brake pedal 31, the greater the predetermined value A. In this case, for example, if the driver is strongly depressing the brake pedal 31, the engine 2 is not restarted unless the accelerator pedal 30 is depressed correspondingly strongly.

Therefore, the IS-ECU 14 is designed so that if the both-pedal depression state occurs during an automatic stop of the engine 2 and the accelerator operation amount is less than the predetermined value A, restart of the engine 2 is prohibited. Furthermore, if the first condition is changed as stated above, the IS-ECU 14 outputs a signal that indicates the changing of the first condition to the meter ECU 15.

The meter ECU 15 is constructed of a microprocessor that includes a CPU, a ROM, a RAM, a flash memory and an input/output port (none of which is shown in the drawings). Programs for causing the microprocessor to function as the meter ECU 15 are stored in the ROM of the meter ECU 15.

That is, the microprocessor functions as the meter ECU 15, because the CPU of the meter ECU 15 executes the programs stored in the ROM by using the RAM as a working area.

The meter ECU 15 is designed so as to communicate with other ECUs, such as the EG-ECU 10, the IS-ECU 14, etc., via the high-speed CAN, and send and receive various control signals and data to and from the other ECUs such as the EG-ECU 10, the IS-ECU 14, etc.

The combination meter 18 that displays various kinds of information regarding the present state of the vehicle is connected to the output side of the meter ECU 15. The combination meter 18 is disposed in an instrument panel that is provided in a cabin of the vehicle 1.

Furthermore, in the combination meter 18, there are provided an IS indicator 18a for notifying the driver that the idle stop control is being executed, and a both-pedal depression indicator 18b that notifies the driver that the both-pedal depression state in which both the brake pedal 31 and the accelerator pedal 30 are depressed is present.

If the both-pedal depression state occurs during the automatic stop of the engine 2 and the first condition has been changed, that is, if a signal indicating that the first condition has been changed is input from the IS-ECU 14, the meter ECU 15 notifies a driver of the changing of the first condition via the combination meter 18.

Concretely, if the signal indicating that the first condition has been changed is input from the IS-ECU 14, the meter ECU 15 blinks the IS indicator 18a and the both-pedal depression indicator 18b synchronously to notify the driver that the first condition has been changed due to depression of the two pedals. Thus, the combination meter 18 equipped with the IS indicator 18a and the both-pedal depression indicator 18b constitutes notification means.

Incidentally, although the meter ECU 15 in accordance with the embodiment is configured so that if the signal indicating the changing of the first condition is input from the IS-ECU 14, the meter ECU 15 notifies the driver of the changing, this is not restrictive. For example, the meter ECU 15 may also be configured to notify the driver that the both-pedal depression state is present on the basis of input of a signal indicating the both-pedal depression state from the IS-ECU 14.

Furthermore, the foregoing notifying methods using the IS indicator 18a or the both-pedal depression indicator 18b are not restrictive, but various other notifying methods can also be adopted. For example, in addition to or instead of the foregoing methods, it is permissible to carry out the notification by alarm sound.

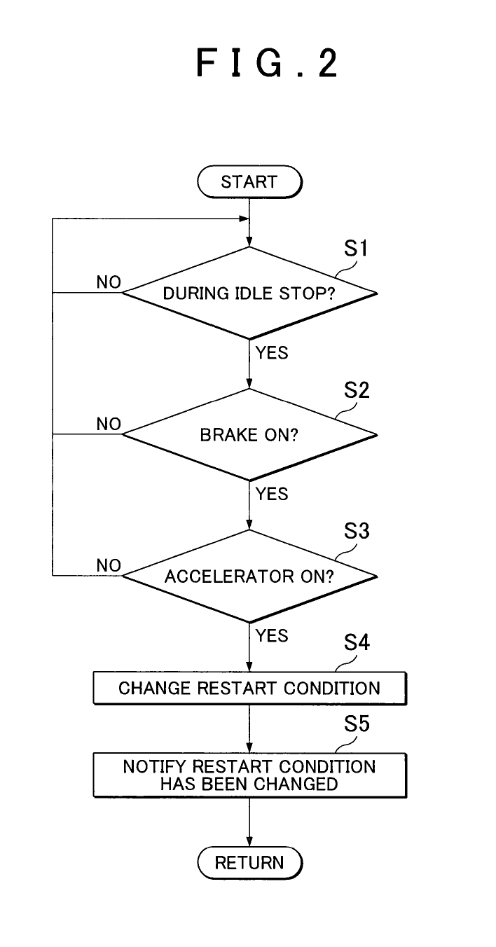

Next, with reference to FIG. 2, an engine restart condition changing process executed by the IS-ECU 14 in accordance with the invention will be described. The engine restart condition changing process shown in FIG. 2 is executed at pre-set time intervals during execution of the idle stop control.

As shown in FIG. 2, the IS-ECU 14 determines whether the vehicle 1 is in the idle stop, that is, whether the engine 2 is in the automatic stop (step S1). If the IS-ECU 14 determines that the vehicle 1 is not in the idle stop, the IS-ECU 14 repeats this step.

On the other hand, if it is determined that the vehicle 1 is in the idle stop, the IS-ECU 14 determines whether the brake is on, that is, whether the brake pedal 31 has been depressed (step S2). If it is determined that the brake is not on, the IS-ECU 14 returns to step S1.

On the other hand, if it is determined that the brake is on, the IS-ECU 14 determines whether the accelerator is on, that is, whether the accelerator pedal 30 has been depressed (step S3). In this step, it is determined whether the both-pedal depression state is present. If it is determined that the accelerator is not on, the IS-ECU 14 returns to step S1.

On the other hand, if it is determined that the accelerator is on, the IS-ECU 14 changes the engine restart condition in the idle stop control (step S4). Concretely, IS-ECU 14 changes the first condition, which is one of the engine restart conditions, from the condition that the accelerator pedal 30 has been depressed to the condition that the accelerator pedal 30 has been depressed to or beyond a predetermined value (predetermined accelerator operation amount) A set beforehand.

Subsequently, the IS-ECU 14 notifies that the engine restart condition has been changed, more specifically, that the first condition ha& been changed (step S5). Concretely, the IS-ECU 14 outputs the signal indicating the changing of the first condition to the meter ECU 15, so that the meter ECU 15 notifies the driver via the combination meter 18 that the first condition has been changed due to depression of the two pedals. At this time, the meter ECU 15 performs this notification by blinking the IS indicator 18a and the both-pedal depression indicator 18b synchronously with each other.

As described above, the vehicle control apparatus in accordance with the invention, if both the brake pedal 31 and the accelerator pedal 30 are depressed during the automatic stop of the engine 2, changes the first condition concerning the accelerator pedal 30 to the condition that the accelerator pedal 30 is depressed to or beyond the predetermined value A set beforehand, so that it is less easy to restart the engine 2.

Therefore, restart of the engine 2 is restricted, for example, when, while keeping the brake pedal 31 depressed, a driver puts his/her foot on the accelerator pedal 30 without an intention to launch the vehicle. On the other hand, if, while keeping both the accelerator pedal 30 and the brake pedal 31 depressed, the driver depresses the accelerator pedal 30 to or beyond the predetermined value A with an intention to launch the vehicle, the engine 2 is restarted. Therefore, the vehicle control apparatus in accordance with this embodiment is able to restart the engine 2 according to the driver's intention at the time of return from the idle stop control.

Furthermore, in the case where, on an uphill road or the like, while keeping the brake pedal 31 depressed, a driver depresses the accelerator pedal 30 so as to restart the engine 2 and launch the vehicle, the engine 2 is restarted after the accelerator pedal 30 is depressed to or beyond the predetermined value A; therefore, a sufficient drive force can be generated at the time of launching the vehicle, in comparison with the case where restart of the engine is performed while the depression of the accelerator pedal 30 is small. This makes it possible to restrain the vehicle 1 from descending backward at the time of launch on an uphill road or the like. Therefore, the vehicle control apparatus in accordance with this embodiment is able to improve vehicle launch performance on an uphill road or the like.

Furthermore, the vehicle control apparatus in accordance with the embodiment prohibits restart of the engine 2 if the amount of depression of the accelerator pedal 30 is less than the predetermined value A while both the brake pedal 31 and the accelerator pedal 30 are in depressed states during the automatic stop of the engine 2. Therefore, if the accelerator pedal 30 is depressed by a driver's operation error when the driver does not intend to launch the vehicle, restart of the engine 2 can be restrained according to the driver's intention.

Furthermore, in accordance with the embodiment, if during the automatic stop of the engine 2, both the brake pedal 31 and the accelerator pedal 30 are depressed and the first condition is changed so that it is less easy to restart the engine 2, the vehicle control apparatus notifies a driver of the changing of the first condition. Therefore, it is possible to restrain unintentional launch of the vehicle or the like due to a driver's depressing the accelerator pedal 30 based on, for example, the driver's misunderstanding of the automatic stop of the engine 2 as an ignition-off state.

Incidentally, although in the embodiment, the accelerator-on state is adopted as the first condition, that is, one of the engine restart conditions in the idle stop control employed when the both-pedal depression state, that is, the state in which both the brake pedal 31 and the accelerator pedal 30 are depressed, is not present (i.e., during a not-both-pedal depression state), this is not restrictive. For example, the first condition employed at the time of the not-both-pedal depression state may also be a condition that the accelerator pedal 30 is depressed to or beyond a predetermined value (predetermined amount of accelerator operation) B set beforehand.

It is to be noted herein that the predetermined value B is smaller than the predetermined value A concerning the first condition employed during the both-pedal depression state (the predetermined value A>the predetermined value B). Therefore, during the not-both-pedal depression state, the engine 2 is restarted on the condition that the accelerator operation amount becomes equal to or greater than the predetermined value B, whereas during the both-pedal depression, the engine 2 is restarted on the condition that the accelerator operation amount becomes equal to or greater than the predetermined value A that is greater than the predetermined value B. Incidentally, in this case, the “accelerator pedal being depressed” concerning the first condition employed during the not-both-pedal depression state is a concept that includes the accelerator pedal 30 being depressed to or beyond the predetermined value B. Furthermore, the “predetermined value” concerning the first condition employed during the both-pedal depression state means the predetermined value A that is greater than the predetermined value B.

Furthermore, although in the embodiment, a driver is notified via the combination meter 18 that the first condition, that is, one of the engine restart conditions employed in the idle stop control, has been changed, this is not restrictive. For example, it is also permissible to adopt a construction in which both or one of the accelerator pedal 30 and the brake pedal 31 is vibrated to notify a driver of the changing of the first condition. In this case, the vehicle 1 is equipped with an actuator for vibrating the accelerator pedal 30 and/or the brake pedal 31. This actuator is connected to the IS-ECU 14.

As described above, the vehicle control apparatus in accordance with the invention is able to perform restart the internal combustion engine commensurate with the intention of a driver at the time of return from the idle stop control, and is therefore useful as a vehicle control apparatus that is mounted in a vehicle capable of executing the idle stop control.

1. A vehicle control apparatus for a vehicle that executes an idle stop control of automatically stopping an internal combustion engine when a predetermined engine stop condition is satisfied, and restarting the internal combustion engine when a predetermined engine restart condition is satisfied, the control apparatus comprising:
a first sensor configured to detect amount of depression of an accelerator pedal;
a second sensor configured to detect amount of depression of a brake pedal; and
a controller configured to determine that the predetermined engine restart condition is satisfied as a first condition when the accelerator pedal is depressed and the brake pedal is released, and
the controller being configured to determine that the predetermined engine restart condition is satisfied as a second condition when the accelerator pedal is depressed beyond the amount of depression of the accelerator pedal at which the first condition is satisfied while both the brake pedal and the accelerator pedal are depressed during an automatic stop of the internal combustion engine.

2. The control apparatus according to claim 1, wherein while both the brake pedal and the accelerator pedal are depressed during the automatic stop of the internal combustion engine, the controller notifies a driver that both the brake pedal and the accelerator pedal are depressed during the automatic stop of the internal combustion engine.

3. A vehicle control method for a vehicle that executes an idle stop control of automatically stopping an internal combustion engine when a predetermined engine stop condition is satisfied, and restarting the internal combustion engine when a predetermined engine restart condition is satisfied, the control method comprising:
detecting, by a first sensor, amount of depression of an accelerator pedal;
detecting, by a second sensor, amount of depression of a brake pedal;
determining, by a controller, that the predetermined engine restart condition is satisfied as a first condition when the accelerator pedal is depressed and the brake pedal is released; and
determining, by the controller, that the predetermined engine restart condition is satisfied as a second condition when the accelerator pedal is depressed beyond the amount of depression of the accelerator pedal at which the first condition is satisfied while both the brake pedal and the accelerator pedal are depressed during an automatic stop of the internal combustion engine.
